(19) United States
(12) Patent Application Publication
(10) Pub. No.: US 2019/0019146 A1
(43) Pub. Date: Jan. 17, 2019

(54) SYSTEM AND METHOD FOR ARRANGING DELIVERIES AND RIDE SHARINGS

(71) Applicants: Rajaa Chraibi, Sherman Oaks, CA (US); Michael Zokai, Beverly Hills, CA (US)

(72) Inventors: Rajaa Chraibi, Sherman Oaks, CA (US); Michael Zokai, Beverly Hills, CA (US)

(21) Appl. No.: 15/651,326

(22) Filed: Jul. 17, 2017

(51) Int. Cl. G06Q 10/08

(52) U.S. Cl. CPC G06Q 10/0834; G01C 21/3438

(57) ABSTRACT

A system and method can arrange a delivery service, wherein the delivery service request may include an item-delivery request, a ride-sharing request, or both. In some embodiments, to arrange the delivery service, the present invention may receive a courier's route and compare the route with at least one delivery request. If the delivery request and the route are compatible, the present invention may provide for the courier to accept the delivery request and may monitor the completion of the delivery request. In some embodiments, the route may traverse ground, water, or air, and may comprise a plurality of stops. Additionally, the route may be configured as a path between two points, or may comprise an area on a map.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to on-demand transport, and more particularly, to a system, method, and apparatus for arranging deliveries and ride sharing.

### BACKGROUND

A variety of location-based mobile applications exist on the market. Such applications provide a service based on the user's location. A “maps” application, for example, ascertains the user's location, then uses a Global Positioning System (“GPS”) to provide a service to the user, such as displaying a way to a destination. Another example is a restaurant-recommendation mobile application that shows a user restaurants within a certain distance of the user's location, along with other relevant information. Even dating applications modify their offerings based on a user's location.

Ride-sharing is a particularly prominent location-based service. Using GPS, ride-sharing mobile applications match a potential ride-sharing customer with a driver in her area. In many respects an on-demand taxi service, ride-sharing applications accept a transportation request from a user that includes a pickup location and a drop-off location, then provide the pickup location to a potential driver. Once the ride portion of the service is initiated, the driver is provided with the drop-off location. The benefits of ride-sharing applications are well-known. However, ride-sharing applications are limited to transporting humans and their associated baggage. As such, persons wanting to arrange transport for an object in a manner similar to the ride-sharing model are unable to do so.

Examples of ride sharing disclosures abound. For example, U.S. Pat. No. 9,551,586 to Uber Technologies, Inc., which is incorporated by reference in its entirety herein, generally discloses a system that supplements GPS information with contextual information, thus better enabling drivers to find a particular location. For example, a user may not know the street address associated with either the desired pickup or drop-off location. This disclosure enables a driver to receive supplementary information, in some cases from the user, that clarifies GPS information.

Another example can be seen with respect to U.S. Patent Application Publication No. 2016/0034845 A1, also filed by Uber Technologies Inc. and incorporated by reference in its entirety herein. This disclosure generally provides for a single driver to ferry multiple passengers according to an overlapping series of pickup and drop-off locations.

Yet another example can be seen with respect to U.S. Patent Application Publication No. 2016/0027306 A1 filed by Lyft, Inc. incorporated by reference in its entirety herein. This disclosure generally provides for a “ride chaining” functionality wherein a driver can accept a consecutive series of ride sharing requests.

While the above-referenced disclosures provide for a multiplicity of ride sharing functionalities, these disclosures and others like them tend to provide that the transportation route is determined by the passenger, rather than the driver. Unfortunately, these disclosures and others like them fail to provide for a functionality wherein the driver independently chooses a route and users can request that the driver perform a service while the driver is en route.

Additionally, item delivery is also a prominent location-based service. Generally, item delivery services allow a user to identify one or more items, each item having a pickup location and a delivery location, and request a delivery schedule for each item. Then, the service assigns a team member to execute the deliveries per the user's request. Typically, the urgency of the delivery request determines the item service's cost, with more urgent requests being more costly.

Examples of relevant delivery systems, methods, and apparatus are also available. For instance, disclosures such as U.S. Patent Application Publication No. 2002/0152128 A1, incorporated by reference in its entirety herein, provide for delivery systems and methods involving multiple stops, multiple items, and multiple customers. Such a disclosure analyzes large amounts of data in order to prioritize and arrange the service in an efficient manner.

Other related location-based services could include personal shopper, personal assistant, or personal care services.

Many of these disclosures and services are configured such that the user's request dictates the service provider(s)′ path of travel. Or, other services offer the user a lower cost if the user is willing to let the service provider's path of travel dictate the terms of the delivery. As such, these and other similar disclosures fail to provide for a delivery service that can transport either people (e.g. ride sharing) or items (e.g. item delivery service) according to a route determined by the service provider, rather than by the end user, and that can easily do so on an expedited timeline without additional cost to the end user.

### SUMMARY

The present invention may provide for a user to engage the present invention as a “courier” willing to transport an item or person (collectively, “thing(s)”) or as a “requesting party” who wishes to have a thing transported. A requesting party may indicate this desire through a “delivery request,” which may comprise an item-delivery request, a ride-sharing request, or both. A courier may provide for at least one “route,” which is herein intended to be a direction, path, or area in which a courier is willing to transport things. As used herein, the term “user” may refer to either a courier or a requesting party, or any other user of the present invention. In some embodiments, a user may occupy the role of courier, requesting party, or both, or in alternation, at any time, as appropriate to the user's use of the present invention. Additionally, in some embodiments, users may be companies. In some embodiments, a business may serve as a depository or transit stop for users of the present invention.

Examples described herein provide for a system, method, and apparatus for arranging a delivery service, ride sharing, or both, (herein, “the system”) between at least one requesting party and at least one courier. In some embodiments, the present invention may receive at least one route as inputted by at least one courier as an “announcement.” Additionally, the present invention may receive at least one delivery request from at least one requesting party inputted as a “request.” In some embodiments, the present invention may compare the delivery request(s) with the route(s) to determine if the delivery request(s)′ pick-up and drop-off points lie along the route(s). The present invention may inform one or more couriers of any delivery requests that are compatible with the couriers' route(s), and may inform one or more requesting parties of any couriers' routes that are compatible with the requesting party's delivery request(s). In some embodiments, the present invention may facilitate a courier performing the delivery request(s) by, for example and not limitation, connecting the courier and the requesting party, facilitating communication and negotiation between the courier and the requesting party, and by monitoring performance of the delivery request. In some embodiments, the present invention may also facilitate a fee or payment transfer between one or more users, as well as accept and display users' ratings of other users.

Additionally, in some embodiments, the present invention may provide for an “offers” function, which may in some embodiments resemble a “bulletin board.” In some embodiments, the offer function may provide that at least one requesting party may post at least one delivery request or at least one courier may post at least one route. In some embodiments, the present invention may provide for a plurality of couriers to view, and in some embodiments to interact with, the at least one delivery request. In some embodiments, the present invention may provide for a plurality of requesting parties to view, and in some embodiments to interact with, the at least one route. Once another party has shown interest in an offer, the present invention may enable contact between the two users.

In some embodiments, the present invention may provide that the courier utilize any mode of transportation, such as by way of illustration and not limitation, an automobile, bicycle, airplane, or on foot. Additionally, in some embodiments, the present invention may provide that the courier use a series or combination of transportation modes. In some embodiments, the mode of transportation may be an essential element of an announcement, a request, or an offer.

In some embodiments, the present invention may provide that the route is determined by a courier. It is contemplated that the courier may do so my entering beginning and ending location information into a maps application, whereupon the maps application may plot the route. In other embodiments, the courier may draw the route on the maps program. In some embodiments, the present invention may provide for a curved path between two points. In some embodiments, the present invention may draw a curved path between two points if the distance is below a certain threshold, such as by way of illustration and not limitation 8 km, and one or more straight lines if the distance is above a certain threshold.

In some embodiments, the route may be represented as a general area on a map application screen in which the courier is willing to travel. The present invention may provide that in order to select the general area in which the courier is willing to travel, the present invention may provide for one or more drop-down menus that provide selectable options including, but not limited to, a radius of five, ten, twenty-five, fifty, one hundred, or one hundred and fifty (5, 10, 25, 50, 100, 150) miles based on the user's current location. In some embodiments, the radius may be calculated from one or more points along an existing route, such as for example five miles in any direction from the route. In some embodiments, the user may select a general area by drawing the area on the map application screen. In some embodiments, such as by way of illustration and not limitation ground transportation, the radius may cover the entire route from start to finish (or, source to destination, as appropriate). In some embodiments, such as by way of illustration and not limitation air transportation, the radius may specify areas around one or more departing, layover, and/or destination locations.

In some embodiments, the present invention may provide that one or more elements of information are available from or presented on the map screen, in addition to route information. Such information could include, by way of illustration and not limitation, information such as the location, identity, direction of travel, status, or other aspects of a courier, a requesting party, another user, an item, person, or thing, affiliated business, drop off or pickup points, alternative routes, user ratings, or any other aspect of the present invention capable of presentation on a map screen. Additionally, in some embodiments, the icons or displays of information may update and move on the map screen in real time.

In some embodiments, a requesting party may use either or both of route information and one or more other elements of information as generally discussed herein, to select a particular courier for one or more delivery requests. In some embodiments, the requesting party may send a notification directly to the selected courier, rank two or more couriers in order of preference, or otherwise select from a group of couriers. Relatedly, in some embodiments, using the route information and map information generally discussed herein, a courier may select a particular requesting party or parties based on one or more delivery requests. In some embodiments, the courier may send a notification directly to the selected requesting party or parties, rank two or more requesting parties in order of preference, or otherwise select from a group of requesting parties. It is therefore contemplated that a user may use the present invention to select another user within a certain area, such as within or along a route, for one or more delivery requests. It is also contemplated that, similarly, an announcement may be targeted to one or more users within or along a route.

In addition to a map-based selection system, in some embodiments the present invention may present users to other users in ordered (for example, ascending or descending) lists based on rankings as determined by one or more algorithms evaluating one or more criteria. By way of illustration and not limitation, assuming the relevant user is within the proper distance and other compatibility factors, a user may be able to select another user for a delivery arrangement based on whether the other user is a “Best Rated User,” a “Fastest User,” or a “Cheapest User.” For “Best Rated User,” the present invention may utilize one or more algorithms to determine which user has the highest rating score(s) across one or more criteria. For “Cheapest User,” in some embodiments, the present invention may utilize one or more algorithms to determine which user charges the least for the relevant type of delivery request. For “Fastest User,” in some embodiments, the present invention may utilize one or more algorithms to determine which user completes delivery requests in the shortest amount of time, after factoring in various parameters.

In some embodiments, the present invention may provide that a payment (“fee”) may be associated with the delivery service. In some embodiments, the present invention may provide that the fee may be set by the present invention according to one or more algorithms or parameters, by a requesting party, by a courier, by negotiation between a courier and a requesting party, or by one or more couriers and one or more requesting parties. In some embodiments, the present invention may provide for one or more fee-setting or fee-suggesting factors, such as by way of illustration and not limitation, base fare, booking fee, minimum fare, maximum fare, per minute fare, per mile fare, or any other factor relevant to delivery request fees or fares as known in the art (collectively, “fare factors”). In some embodiments, the present invention may utilize one or more algorithms that may compute one or more fare factors in setting or suggesting a fee. In some embodiments, the present invention may utilize one or more algorithms to set a range of suggested fees. In some embodiments, the present invention may set a lower limit or upper limit for one or more fees. In some embodiments, if a delivery request is cancelled, the present invention may provide for a fee-splitting element wherein a user may be refunded all, part, or none of the fee. In some embodiments, the present invention may utilize one or more algorithms to compute one or more factors with respect to the cancellation fee determination, such as but not limited to, whether the cancellation was made before or during performance of the delivery request and what actions a courier took before the cancellation, such as how far the courier traveled before the cancellation was finalized.

The present invention may also provide for one or more usage tracking features, wherein a user may track, classify, or analyze one or more users' interaction(s) with the present invention. By way of illustration and not limitation, such features may include the ability to classify a route, a delivery request, the performance of a delivery request, a payment transmitted or received, a message sent or received, time spent posting or performing a delivery request, or other usage of the present invention as business, personal, or a combination of business and personal. Additionally, the present invention may provide an accounting of, for example, time spent using the present invention, numbers of delivery requests posted or performed, payments sent or received, messages sent or received, announcements posted or viewed, or other use(s) of the present invention. The present invention may also provide a feature that analyzes a user's use of the present invention, such as by way of illustration and not limitation, suggesting times or locations wherein a user may maximize the user's financial benefit from posting or performing a delivery request, alternate routes or other means for performing delivery requests more rapidly, optimizing the types of items or numbers of persons per delivery request based on the user's mode of transport, and other such suggestions. In some embodiments, the present invention may compile any element of data and provide the data to a user as a document.

In one or more embodiments, the present invention may provide that the delivery arrangement system comprises a first interface for receiving a courier's planned path of travel; a second interface for receiving a delivery service request including an item or person description, or both, a pickup location, and a drop-off location; a delivery compatibility selection interface that determines whether the courier's planned path of travel and the delivery request are compatible; and an output interface providing the delivery request to the courier, wherein the output interface is further for receiving a courier acceptance.

In some embodiments, the delivery compatibility selection interface may comprise one or more algorithms that may calculate the distance between one or more couriers and one or more delivery request's pick up or drop off locations, calculate distance between users, compare one or more distances to one or more elements of a delivery request, a courier's preferences, or available data such as current traffic conditions, and make a determination about the fit between the delivery request and one or more couriers. In some embodiments, if the present invention determines that a delivery request is compatible with a courier, the present invention may send an alert, a notification, a message, or another communication to the computing device associated with a courier, a requesting party, or another user. In some embodiments, it is contemplated that the delivery compatibility selection interface may operate substantially the same if the delivery request pertains to an item delivery request, a ride sharing request, or both an item delivery and a ride sharing request. In some embodiments, one or more algorithms employed by the present invention may differ if the delivery request is an item delivery request, a ride sharing request, or both an item delivery and a ride sharing request.

The present invention may also receive, process, and compare other delivery requests with the courier's route, and if the second delivery request is compatible with the route, in some embodiments the present invention may allow the courier to accept the second delivery request as well. The present invention may be able to receive, process, compare, and assign one, two, three or more delivery requests per route.

Depending on the various computational operations wherein the present invention compares multiple itineraries with a delivery request, the present invention may determine that a delivery request is best accomplished using more than one courier. In such a scenario, the present invention may arrange for a transfer of the item(s) or person(s), or both, from a first courier to a second courier.

In some embodiments, a courier's announcement may include, such as by way of illustration and not limitation, an announcement of availability to perform services or complete a delivery request, whether the courier is traveling by ground, air, water, or a combination of ground, air, or water, what vehicle the courier is using, details concerning the courier's carrying capacity, an invitation by a courier to requesting parties to bid on the courier's services, a courier's location, a courier's route, a geographic area in which a courier is available to complete delivery requests, a courier's preferences, or any other announcement compatible with the present invention.

A ride sharing request may include such elements as, by way of illustration and not limitation, at least one of the following: a person identified for pickup, a pickup location, a drop-off location, and an element of requesting party information. In some embodiments, such elements of requesting party information may include, by way of illustration and not limitation, a requesting party's name, payment information, physical description, preferences, handicaps or other special needs, luggage requirements, and/or any other information element pertinent to a ride-sharing request. In some embodiments, the present invention may also provide fillable blanks wherein a requesting party may specify one or more elements of information pertinent to a ride-sharing request. Such fillable blanks may include, by way of illustration and not limitation: where from; where to; number of seats needed; number of people to transport; number of luggage pieces; size of luggage piece(s); when pickup desired; when drop-off desired; time after which request no longer valid; time at which the request becomes valid; any other category of information capable of integration within the present invention; and any equivalent or alternate phrasing of any such item of information.

Similarly, an item delivery request may include at least one of the following: a pickup item, a pickup location, a delivery location, and an element of requesting party information. In some embodiments, such elements of requesting party information may include, by way of illustration and not limitation, a requesting party's name, payment information, physical description, preferences, handicaps or other special needs, as well as the item(s)′ dimensions, weight, characteristics, condition, properties, and/or any other information element pertinent to an item delivery request. In some embodiments, the present invention may also provide fillable blanks wherein a requesting party may specify one or more elements of information pertinent to an item delivery request. Such fillable blanks may include, by way of illustration and not limitation: where from; where to; when pickup desired; when drop-off desired; time after which request no longer valid; time at which the request becomes valid; estimated weight of each item; estimated total weight; item description; item name/title; item quantity; any other category of information capable of integration within the present invention; and any equivalent or alternate phrasing of any such item of information.

In some embodiments, a user may also input one or more elements of user profile information into the present invention, such as by way of illustration and not limitation: the user's first name, last name, email, and profile picture, what kind of vehicle the user operates, the capacity of the user's vehicle, bank account information, and one or more user preferences.

The present invention may also provide one or more real-time tracking features, such as by way of illustration and not limitation, wherein a user may view another user's location, the status of a delivery request, a user's current rating, the status of a payment, along with any other similar feature compatible with the present invention.

Additionally, it is also contemplated that in some embodiments, a user may message another user via the present invention at any time, provided that both users have indicated the appropriate preferences within the present invention. In some embodiments, one or more message functions may only be provided once a delivery request has been sent or posted. In some embodiments, one or more message functions may only be provided once a delivery request has been accepted.

The present invention may also provide for one or more rating functions, wherein any user may be rated by any other user. Criteria for evaluation may include, by way of illustration and not limitation, a star-rating system, a fillable text box suitable for comments, or designations such as “Best Rated User,” Fastest,” “Cheapest,” or any other such designation. In some embodiments, users may achieve a rating based on consensus or aggregate ratings provided by other users. In some embodiments, each user may have a rating system comprising only that user's ratings for other users. In some embodiments, a user may have more than one rating, or more than one of each type of rating. For example, a user may be “Best Rated” with respect to a certain type of delivery request, in an area, to a user, to a group of users, system-wide, or a combination of these or other categories.

It is contemplated that the present invention may enable users to transport themselves, others, or items efficiently and economically. The present invention may also enable couriers to conveniently perform transport services without having to go substantially out of their way.

In some embodiments, the present invention may provide that couriers, requesting parties, or businesses may substitute their logo for the moving blue dot, or other location indicator, in a maps program as integrated into or accessed by the present invention. In some embodiments, the logo may provide for one or more hyperlinks that, when clicked upon, may direct the person or machine that may interact with the hyperlink to a website. Additionally, in some embodiments, the present invention may illustrate persons of interest walking along the map images or application.

In some embodiments, a courier may utilize a motorcycle, a car, a truck, a bicycle, a plane, a skateboard, a boat, bipedal bodily movement, assisted movement devices, or any other form of transportation. In some embodiments, the present invention may provide that a requesting party may select or otherwise filter the user or requesting party's delivery request by type of vehicle.

In addition to ride sharing or item delivery, some embodiments, a delivery request may also include a request for other services, such as by way of illustration and not limitation, requests for medical, car wash, landscape, plumbing, dog walking, or maid services, along with any other type of service that can be found around a current location.

In some embodiments, the present invention may provide for a “group” functionality wherein requesting parties or couriers may make requests or announcements to a group of people based on a unifying factor beyond geographical location. For example, the group could include coworkers in an office, a building floor, a school, a party or other type of group or gathering.

In some embodiments, the present invention may integrate with or support, or be supported by, a social media platform, wherein requesting parties, couriers, and other persons familiar with the present invention may share their experience.

In some embodiments, the present invention may provide a Health Emergency/Police Button Request button. Such a feature may enable any user to inform the closest health worker, police officer, or ambulance about an emergency to which the user is a witness.

Additionally, in some embodiments, the present invention may support a live video feed function, wherein live video along with photos may be uploaded and distributed either over broadcast, wired cable connections, or the internet. Additionally, this functionality may provide for a text message or other “silent” functionality wherein a person may unobtrusively report on events to which the requesting party is a witness. In some embodiments, in the spirit of efficiency and haste, the present invention may also provide for a drop-down list from which a requesting party may select and indicate the crime the requesting party believes is transpiring. By way of illustration and not limitation, such a drop-down list may include robbery, murder, blackmailing, or other crime. In some embodiments, the selected item from the drop-down list may be communicated discretely to the police instead of by voice on a 911 call.

In some embodiments, a user may be awarded gold, silver, or bronze tags based on their performance and reviews from other users.

One or more examples described herein may provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example or embodiment described herein (including with the performance of any method or with the implementation of any system).

Furthermore, one or more examples described herein may be implemented through the use of instructions that are executable by one or more processors. These instructions may be carried on a computer-readable medium. Additionally, at least one embodiment of the invention is implemented as a program product for use with a computer system. The program(s) of the program product defines functions of the embodiments (including the methods described herein) and can be contained on a variety of computer-readable storage media. Machines that may be shown or described with figures provide illustrative examples of processing resources and such computer-readable mediums on which instructions for implementing examples described herein can be carried and/or executed. In particular, the numerous machines shown with examples or described herein include processor(s) and various forms of memory for holding data and instructions.

Illustrative computer-readable storage media or computer storage mediums include, but are not limited to: (i) non-writable storage media or permanent memory storage devices (e.g., read-only memory devices within a computer such as CD-ROM disks readable by a CD-ROM drive) on which information is permanently stored; (ii) writable storage media (e.g., floppy disks within a diskette drive or a hard-disk drive on personal computers or servers) on which alterable information is stored, and (iii) portable storage memory, such as CD or DVD units, flash memory (such as carried on smartphones, multifunctional devices or tablets), and (iv) other memory, such as magnetic memory. Such computer-readable mediums, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media. Computers, terminals, network enabled devices (e.g., mobile devices, such as cellphones) are all examples of machines and devices that utilize processors, memory, and instructions stored on computer-readable mediums.

In general, the routines executed to implement the embodiments of the invention, may be part of an operating system or a specific application, component, module, object, sequence of instructions, computer program(s), or a computer usable carrier medium capable of carrying such a program. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

One or more of the above-disclosed embodiments, in addition to certain alternatives, are provided in further detail below with reference to the attached figures. The disclosed subject matter is not, however, limited to any particular embodiment disclosed. Thus, the absence of describing combinations should not preclude having rights to such combinations.

### BRIEF DESCRIPTION OF THE DRAWINGS

FIG. 1 is a block diagram of a networked environment in which an exemplary embodiment of a system for arranging deliveries and ride sharing is implemented.

FIG. 2 illustrates an exemplary embodiment of a mobile device shown in FIG. 1.

FIG. 3 illustrates an exemplary method for arranging deliveries and ride sharing, according to one or more embodiments.

FIG. 4 illustrates one or more methods for arranging deliveries and ride sharing pertaining to requests, according to one or more embodiments of the present invention.

FIG. 5 illustrates one or more methods for arranging deliveries and ride sharing pertaining to offers, according to one or more embodiments of the present invention.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

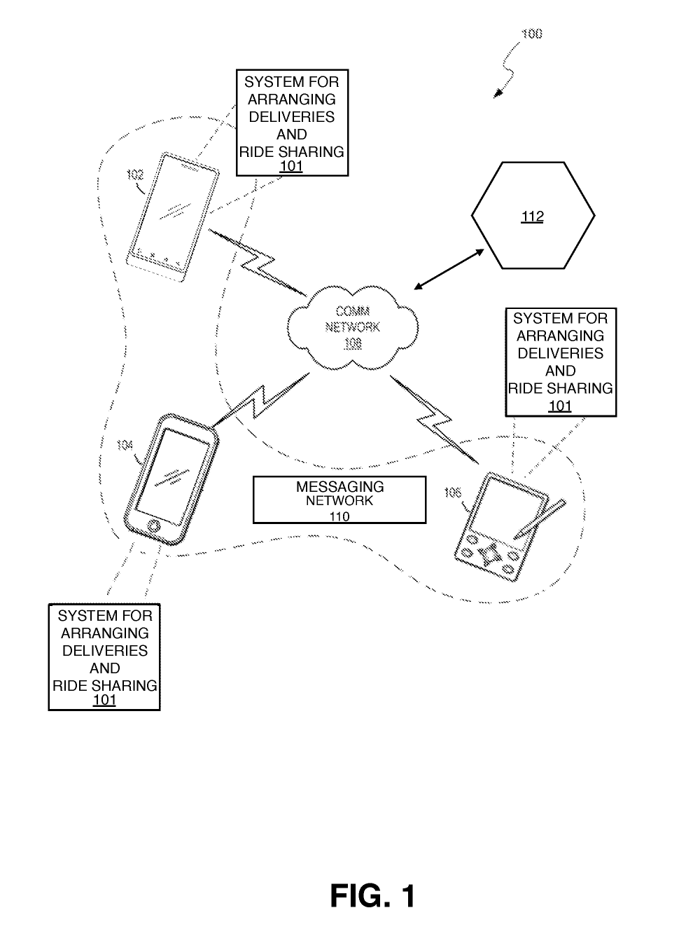

FIG. 1 illustrates an exemplary embodiment of the system 100 which includes a plurality of mobile devices communicatively coupled to one another. By way of example, and not limitation, FIG. 1 illustrates three mobile devices 102, 104, and 106, as well as computing device 112, that incorporate a system for arranging deliveries and ride sharing 101 and are communicatively coupled via a communication network 108. Each of the mobile devices may be embodied as a mobile computing device such as, for example and without limitation, a smartphone or tablet computer that incorporates cellular telephone functionality. Computing device 112 may represent a desktop computer or other computing device not typically mobile. Additionally, communications network 108 can use one or more of various communications types such as, for example and without limitation, cellular and Wi-Fi communications.

It is contemplated that the functionalities of devices 102, 104, 106, and 112 in some embodiments may be all interchangeable, and as such a functionality ascribed to devices 102, 104, 106, or 112 is herein intended to apply equally to any of devices 102, 104, 106, and 112. More specifically, the present invention contemplates that a requesting party, courier, or other user may possess one or more of a mobile device such as 102, 104, and 106 and a computing device 112, and as such unless otherwise specified these terms are herein used interchangeably. By way of non-limiting example, the present disclosure may provide that a communication take place at mobile device 104. In such a circumstance, the present disclosure also contemplates that the communication could equally be received, accessed, altered, etc. at computing device 112. Any device may be associated with any user at any time and for any purpose. When not explicitly specified as such, the reader should infer the interchangeability herein described.

In some embodiments, users of mobile devices 102, 104, and 106 and computing device 112 may be users of a messaging network 110 comprised of at least one existing network known to those skilled in the art. For instance, as noted above, the users of mobile devices 102, 104, and 106 or computing device 112 may be communicatively linked via any one or a combination of FACEBOOK®, TWITTER®, LINKEDIN®, INSTAGRAM®, iMESSAGE®, GOOGLE HANGOUT®, SNAPCHAT®, an email network, or any messaging system that utilizes the internet or wireless communications. Such a messaging network 110 enables anyone, then, to use their mobile devices 102, 104, and 106 or computing device 112 to send electronic messages to each other. In this case, the system for arranging deliveries and ride sharing 101 utilizes an existing network to enable a requesting party to upload or send a delivery request to one or more couriers or to a message board via any of mobile devices 102, 104, and 106 or computing device 112.

Returning to FIG. 1, a messaging network 110 may be facilitated by a website that may require a registration and login prior to use. However, regardless of how such a messaging network 110 is implemented, the functionality of concern involves the ability to communicate with a requesting party, a courier, a company, or the present invention. In an embodiment, the messaging network 110 may be made available to any requesting party of any compatible network. In another embodiment, however, it is contemplated that the messaging network 110 may be accessible to only limited members who register, create a profile, or subscribe.

In one embodiment, the present invention may receive, via a mobile device 102, an route from a courier. Additionally, the present invention may receive, via mobile device 104 or computing device 112, a delivery request. Using processors, computer-readable mediums, a communications network 108, or any other element disclosed herein, the present invention may determine whether the delivery request is compatible with the route. If so, the present invention, via communication network 108, messaging network 110, or both may communicate the delivery request to the courier via device 102, the courier's route to the requesting party via device 104 or computing device 112, or both. If the present invention offers the courier the option to accept or decline, the present invention can receive that indication via device 102, and in some embodiments, may share that information via communication network 108, messaging network 110, or both with the requesting party via device 104 or computing device 112, or both. Similarly, if the present invention offers the requesting party the option to accept or decline the particular courier, the present invention can receive that indication via device 104 or computing device 112, or both, and in some embodiments, may share that information via communication network 108, messaging network 110, or both with the courier via device 102.

The present invention may provide that one or more notifications may be visible to a user on any of mobile devices 102, 104, and 106 or computing device 112, wherein the notification may indicate if and when a delivery request has been created, viewed, sent, announced or posted; if and when a route has been created, viewed, sent, announced or posted; if a delivery request has been negotiated or accepted; if a route has been modified; a delivery request's status; if and when a review has been created, viewed, or posted; if, when and in what amount a payment or fee has been loaded into the system, sent, received, debited or deposited; if a user profile has been created, viewed, accepted, modified, or reported; if a user achieves a milestone; current events or updates, such as traffic or road closures; and any other notification known in the art.

Remaining with FIG. 1, in some embodiments the present invention may receive information concerning the courier's progress from device 102 and, via communication network 108, messaging network 110, or both, may share that information with the requesting party via device 104 or computing device 112, or both. Similarly, the present invention may receive updates, including information related to payments, location, or changes to the delivery request from the requesting party via device 104 or computing device 112, or both, and may share that information with the courier via communication network 108, messaging network 110, or both, and device 102.

In one embodiment, the present invention may receive, via a mobile device 102, more than one route from a courier. Additionally, the present invention may receive, via mobile device 104 or computing device 112, a delivery request. Using processors, computer-readable mediums, a communications network 108, or any other element disclosed herein, the present invention may determine which, if any, route is compatible with the delivery request. If the present invention determines that more than one route is compatible with the delivery request, the present invention may perform one or more calculations and determine which route is the best fit with the delivery request. At this point the present invention may either automatically match the best-suited courier to the delivery request, or via communication network 108, messaging network 110, or both may communicate the courier identities to the requesting party via device 104 or computing device 112, or both. The present invention may receive the requesting party's selection of courier(s) via device 104 or computing device 112, or both. If the present invention offers the courier the option to accept or decline, the present invention can present that indication to the courier and receive that indication via device 102, and in some embodiments, may share that indication via communication network 108, messaging network 110, or both with the requesting party via device 104 or computing device 112, or both.

In one embodiment, the present invention may receive, via a mobile device 102, an route from a courier. Additionally, the present invention may receive, via mobile device 104 or computing device 112, more than one delivery request. Using processors, computer-readable mediums, a communications network 108, or any other element disclosed herein, the present invention may determine whether the delivery requests is compatible with the route. If so, the present invention, via communication network 108, messaging network 110, or both may communicate the delivery requests to the courier via device 102, the courier's route to the requesting party via device 104 or computing device 112, or both. In some embodiments, the present invention may offer the courier the option to accept or decline the delivery request(s), and may receive the courier's election, via device 102, and in some embodiments, may share that election via communication network 108, messaging network 110, or both with one or more requesting parties via device 104 or computing device 112, or both. Similarly, in some embodiments, the present invention may offer the requesting party the option to accept or decline the services of a particular courier and may receive that indication via device 104 or computing device 112, or both, and in some embodiments, may share that indication via communication network 108, messaging network 110, or both with one or more couriers via device 102.

In one embodiment, the present invention may provide a forum or “bulletin board” functionality wherein, via a mobile device 102, the present invention may receive at least one route from a courier and post it to a forum interface that may be visible to some or all users. Additionally, the present invention may receive, via mobile device 104 or computing device 112, at least one delivery request and post it to the forum interface that may be visible to some or all users. Using processors, computer-readable mediums, a communications network 108, or any other element disclosed herein, and as mediated by mobile device 102, 104, 106, or computer medium 112, the present invention may enable couriers to accept posted delivery requests and requesting partiess to select couriers for delivery requests.

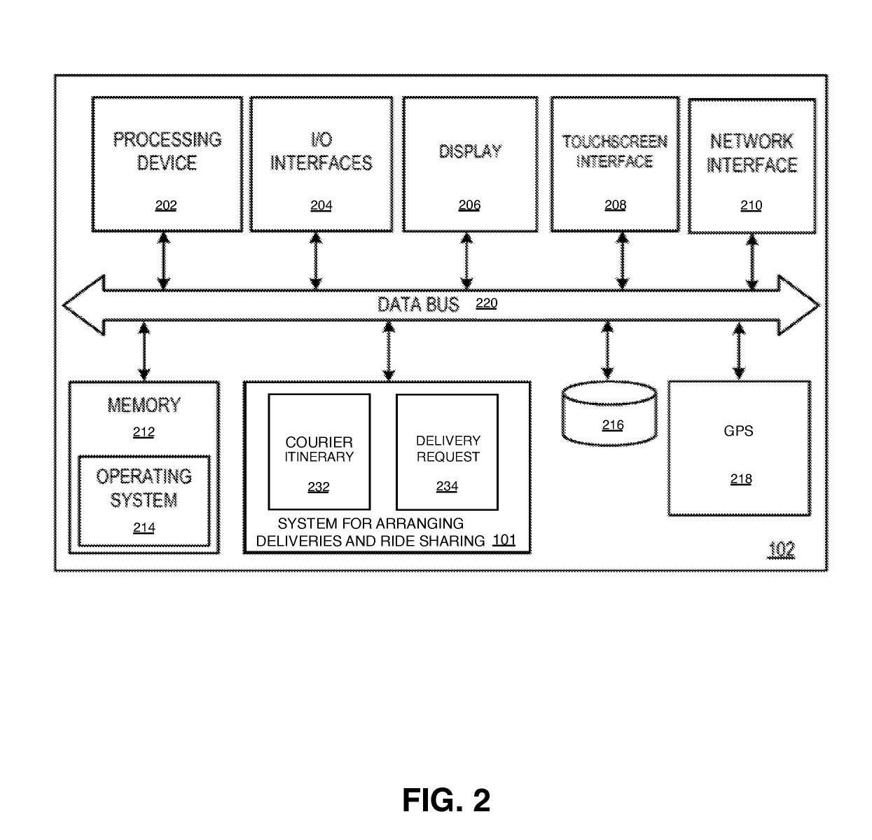

FIG. 2 illustrates mobile electronic device 102 shown in FIG. 1. As described earlier, electronic, or simply mobile, device 102 may be a tablet computer or smartphone but may also be embodied in any one of a wide variety of wired and/or wireless computing devices. As shown in FIG. 2, mobile device 102 includes a processing device (processor) 202, input/output interfaces 204, a display 206, a touchscreen interface 208, which may, in one embodiment, be a physical keyboard, a network interface 210, a memory 212, and operating system 214, a mass storage 216 and an GPS 218, with each communicating across a local data bus 220. Additionally, mobile device 102 incorporates a system for arranging deliveries and ride sharing 101, which is depicted as receiving, at least, data related to at least one courier route 232 and at least one delivery request 234 although the location of courier route 232 and delivery request 234 could vary.

The processing device 202 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 212 can include any one of a combination of volatile memory elements (e.g., random-access memory (RAM, such as DRAM, and SRAM, etc.)) and nonvolatile memory elements. The memory typically comprises native operating system 214, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device. Note that although depicted separately in FIG. 2, the system for arranging deliveries and ride sharing 101 may be resident in memory such as memory 212.

Touchscreen interface 208 is configured to detect contact within the display area of the display 206 and provides such functionality as on-screen buttons, menus, keyboards, etc. that allows users to navigate user interfaces by touch. For some embodiments, the mobile device 102 will comprise GPS 218 or other means to determine the location of the mobile device 102.

One of ordinary skill in the art will appreciate that the operating system 214 can, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 2, network interface device 210 comprises various components used to transmit and/or receive data over a networked environment such as depicted in FIG. 1. When such components are embodied as an application, the one or more components may be stored on a non-transitory computer-readable medium and executed by the processing device.

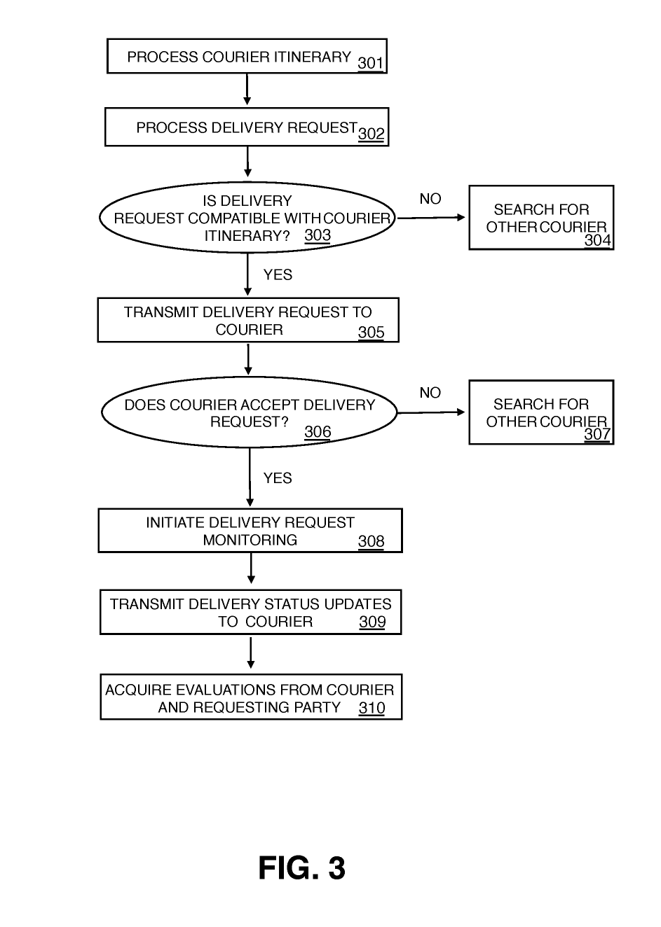

Turning attention to FIG. 3, an exemplary method for arranging deliveries according to embodiments may be seen. FIG. 3 is described with respect to a single courier and a request from a first requesting party. Although not illustrated in FIG. 3, a plurality of couriers may be considered as purveyors of delivery services for a plurality of requesting parties. By way of illustration and not limitation, in some embodiments, a plurality of couriers may be organized into a pool of candidate couriers that may include all drivers whose itineraries could accommodate the delivery request(s). From the pool, the present invention may narrow down the candidate drivers into a “best fit” ranking or order based on, by way of example, a combination of factors such as but not limited to, the driver's route, rating, transportation mode or capacity, personal profile, or any other factor a requesting party (or in some embodiments, the present invention) may deem relevant.

As illustrated in FIG. 3, a method for arranging deliveries may process a courier route 301. In some embodiments, the courier route may be uploaded to the present invention via one or more of the devices generally disclosed in FIG. 1. The route may contain at least a courier identity, a courier location, a courier destination, and a courier's planned path of travel from the courier location to the courier destination. In some embodiments, the courier route may also include information such as, by way of illustration and not limitation, dimensions of the courier's vehicle, occupancy or delivery loads currently utilizing part or all of the available space in the courier's vehicle, courier preferences, courier fuel levels, or any other piece of information that could be legally made available to either the present invention or a requesting party.

In some embodiments, the present invention may receive one or more elements of route information via fillable fields that may be available to the courier via the courier's device. For example, courier identity may be entered by the requesting party into a fillable field entitled “name” provided by the present invention on one or more of the devices generally disclosed in FIG. 1. Similarly, courier location may be entered by the requesting party into a fillable field entitled “current location,” and courier destination may be entered by the requesting party into a fillable field entitled “destination.” In one or more embodiments, once the present invention has received values for current location and destination, the present invention may calculate and determine a courier's planned path of travel from the current location to the destination and display the planned path of travel on a map that may display on the courier's device. Additional, alternate or substitute fillable fields may be matched with additional, alternate or substitute information, such as by way of illustration and not limitation, the other information categories or types listed in this paragraph and elsewhere in this disclosure, as appropriate.

The embodiment may also process one or more delivery requests 302 as uploaded by a requesting party via one or more of the devices generally disclosed in FIG. 1. It is contemplated that in some embodiments, the delivery request may comprise a ride sharing request, an item delivery request, or both. In some embodiments, the delivery request may contain one or more item delivery requests, one or more ride sharing requests, or a combination of one or more item delivery and ride sharing requests.

In some embodiments, an item delivery request may contain one or more of the following: a pickup location, a delivery location, a pickup time, a desired delivery time, a request-expiration time, a total estimated weight of the item(s), and item description(s), wherein the item descriptions contain for each item at least an item name, an item quantity, and an item description. Additionally, the item delivery request may contain alternate information in addition to or in substitution of one or more of the above. The present invention may also receive such information as values entered into fillable fields. For example, pickup location may be entered by the requesting party into a fillable field entitled “from” or “where” provided by the present invention on one or more of the devices generally disclosed in FIG. 1. Similarly, delivery location may be entered into a fillable field entitled “to” or “where to,” pickup time may be entered into a fillable field entitled “when,” desired delivery time may be entered into a fillable field entitled “due by,” a request-expiration time may be entered into a fillable field entitled “valid until,” a total estimated weight of the item(s) may be entered into a fillable field entitled “est. weight,” and item description(s) may be entered into fillable fields for “name,” “quantity,” and “description.” Furthermore, the present invention may also provide one or more drop-down menus that may enable a requesting party to designate whether the item weighs less than one pound (approximately one-half kilogram), between one and five pounds (approximately one-half kilogram to two kilograms), between five and ten pounds (approximately two kilograms to five kilograms), or ten pounds or more (approximately five kilograms or more). Additional, alternate or substitute fillable fields may be matched with additional, alternate or substitute information.

A ride sharing request may contain one or more of the following: a pickup location, a delivery location, a pickup time, a desired delivery time, a request-expiration time, the number of seats desired, the number of people desiring transportation in the request, the number of luggage pieces being transported with the people, and the size of the luggage. Additionally, the ride sharing request may contain alternate information in addition to or in substitution of one or more of the above. The present invention may also capture such information as values entered into fillable fields. For example, pickup location may be entered by the requesting party into a fillable field entitled “from” or “where” provided by the present invention on one or more of the devices generally disclosed in FIG. 1. Similarly, delivery location may be entered into a fillable field entitled “to” or “where to,” pickup time may be entered into a fillable field entitled “when,” desired delivery time may be entered into a fillable field entitled “drop-off by,” a request-expiration time may be entered into a fillable field entitled “valid until,” the number of seats desired may be entered into a fillable field entitled “No. of seats,” the number of people desiring transportation in the request may be entered into a fillable field entitled “No. of people,” the number of luggage pieces being transported with the people may be entered into a fillable field entitled “No. of luggage,” and the size of the luggage may be entered into a fillable field entitled “size.” Additional, alternate or substitute fillable fields may be matched with additional, alternate or substitute information.

The present invention may then perform one or more overlapping or comparing operations and determine whether the delivery request(s) is compatible with the route 303. If the delivery request and the route are not compatible, the present invention may search for another courier and another courier's route 304.

Remaining with FIG. 3, if the delivery request(s) and the route are compatible, the present invention may then transmit the delivery request to the courier 305, wherein the delivery request may include some or all of the ride sharing request elements and/or the item delivery request elements, to the courier via, by way of illustration and not limitation, communications network 108 or messaging network 110, or both, and one or more of devices 102, 104, 106, or 112. The present invention may also enable a fillable field that may be accessible to the courier on the courier's device, wherein the fillable field enables a courier to either accept or decline the delivery request. If the courier declines the delivery request 306, the present invention may process this choice and search for another courier 307. If the courier accepts the delivery request, the present invention may assign the delivery request to the courier.

After the present invention has processed the courier's acceptance of the delivery request and assigned the delivery request to the courier, the present invention may initiate a delivery request monitoring function 308. The monitoring function may receive and process information captured by the courier's device. Non-limiting examples of such information may include real-time or near-real-time location data as mediated by GPS, projected times of arrival or delivery, changes to the delivery request(s), and/or other information relating to one or more aspects of the delivery request, the courier's location, or the courier's progress with respect to the delivery request. In some embodiments, information collected and processed by the monitoring function may be shared with the requesting party(s) via communications network 108 or messaging network 110, or both, and one or more of devices 102, 104, 106, or 112.

Continuing with FIG. 3, the present invention may share information gathered through the delivery request monitoring function or through other sources with the requesting party 309 via communications network 108 or messaging network 110, or both, and one or more of devices 102, 104, 106, or 112. This information may, in some embodiments, be in the form of updates concerning one or more aspects of the delivery request. In some embodiments, the updates may be selected by a requesting party, selected by the present invention, or both. The present invention may also provide for the requesting party(s) to respond to the update(s), alter the delivery request, or take one or more actions by accessing the present invention via the requesting party(s)′ device.

Additionally, the present invention may acquire evaluations from the courier about the requesting party and the requesting party about the courier 310. The requesting party and courier may upload or enter the evaluations into the present invention using a device such as 102, 104, 106, and 112. In some embodiments, the evaluation may use a system such as one to five stars, a one-to-ten rating system, in some embodiments in conjunction with a text box, the collection of which is intended to reflect how the subject of the review performed in the estimation of the reviewer. The present invention may provide that the review, feedback, or rating system and/or other elements of the evaluation may be initiated during the delivery request's execution or after the delivery request's completion.

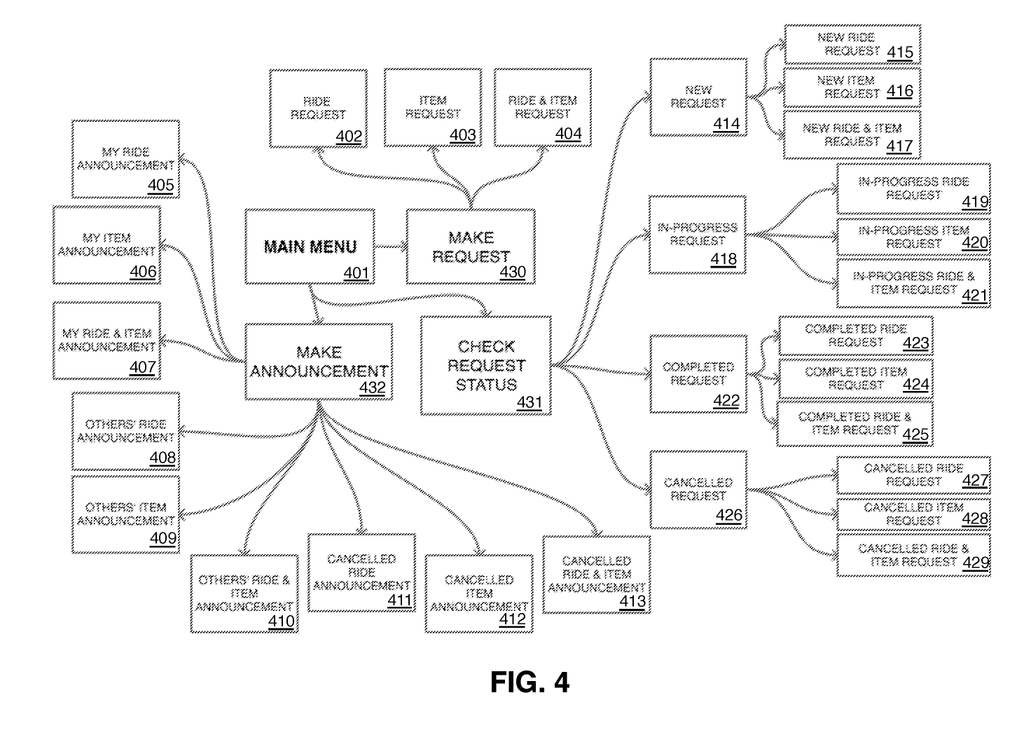

With respect to FIG. 4, a flowchart generally illustrating one or more elements of one or more embodiments of the present invention is generally disclosed. In the embodiment depicted in FIG. 4, the present invention may provide for a home screen 401 that may direct the requesting party or courier to select “make request” 430 “check request status,” 431, or “make announcement” 432.

In some embodiments, after a user selects “make request” 430, the present invention may provide for a requesting party or courier to create a “ride-sharing request” 402, an “item delivery request” 403, or a “ride-sharing and item delivery request” 404.

In some embodiments, after a user selects “make announcement” 432, the requesting party or courier may select from “my ride-sharing announcement” 405, “my item delivery announcement” 406, “my ride-sharing and item delivery announcements” 407, “others' ride-sharing announcement” 408, “others' item announcement” 409, “others' ride-sharing and item delivery announcements” 410, “cancelled ride-sharing announcement” 411, “cancelled item delivery announcement” 412, and “cancelled ride-sharing and item delivery announcements” 413.

Continuing with FIG. 4, in some embodiments after a user selects “check request status” 431, the present invention may provide for a requesting party or courier to select “new request” 414, after which the user may select from “new ride-sharing request” 415, “new item delivery request” 416, and “new ride-sharing and item delivery request” 417.

Remaining with FIG. 4, in some embodiments after a user selects “check request status” 431, the present invention may provide for a requesting party or courier to select “in-progress request” 418, after which the user may select from “in-progress ride-sharing request” 419, “in-progress item delivery request” 420, and “in-progress ride-sharing and item delivery request” 421.

Continuing with FIG. 4, in some embodiments after a user selects “check request status” 431, the present invention may provide for a requesting party or courier to select “completed request” 422, after which the user may select from “completed ride-sharing request” 423, “completed item delivery request” 424, and “completed ride-sharing and item delivery request” 425.

Remaining with FIG. 4, in some embodiments after a user selects “check request status” 431, the present invention may provide for a requesting party or courier to select “cancelled request” 426, after which the user may select from “cancelled ride-sharing request” 427, “cancelled item delivery request” 428, and “cancelled ride-sharing and item delivery request” 429.

In some embodiments, home screen 401 may also contain one or more map functions, in addition to “where from” and “where to” fillable fields, as well as buttons for “make announcement,” “make request,” “check request status” and “menu” functions.

With respect to the “make announcement” 432 screen, the present invention may provide for fillable fields or otherwise allow a requesting party to enter information with respect to “where from,” “where to,” “when,” “valid until,” specify response area,” “announcement type,” and “confirm announcement.” With respect to “specify response area,” the present invention may provide for a map button, which may bring up a map screen along with one or more location pins and one or more mapped routes. With respect to “announcement type,” the present invention may allow a requesting party to select “item,” “ride share,” or “both.” With respect to “confirm announcement,” the present invention may alert the requesting party as to “announcement sent,” “finding people for request on their way,” or another similar message.

Within the “make announcement” 432, the present invention may provide for a user to select from “my announcements,” “others' announcements,” and “cancelled announcements.”

With respect to “my announcements,” the present invention may provide for “ride sharing” or “item delivery” choices. With respect to “my ride-sharing announcement” 405 the present invention may provide for fillable fields or otherwise allow a requesting party to enter information pertinent to “where from,” “where to,” “when,” “valid until,” a map icon that links to a map function, and a “cancel” function button. With respect to “my item delivery announcement” 406 the present invention may provide for fillable fields or otherwise allow a requesting party to enter information pertinent to “where from,” “where to,” “when,” “valid until,” a map icon that links to a map function, and a “cancel” function button. The present invention may provide, in some embodiments, that similar features and sequences may apply to “my ride-sharing and item delivery announcement” 407.

With respect to “others' announcements,” the present invention may provide for one or more “others' ride sharing announcement,” 408 “others' item delivery announcement” 409, and “others' ride-sharing and item-delivery announcement” 410 choices. With respect to “others' ride sharing announcement,” 408 the present invention may provide for fillable fields or otherwise allow a requesting party to enter information pertinent to “where from,” “where to,” “when,” “valid until,” a map icon that links to a map function, and a “cancel” function button. With respect to “item delivery,” the present invention may provide for fillable fields or otherwise allow a requesting party to enter information pertinent to “where from,” “where to,” “when,” “valid until,” a map icon that links to a map function, and a “cancel” function button. It is contemplated that the present invention may provide, in some embodiments, that similar features and sequences may also apply to “others' item delivery announcement” 409, and “others' ride-sharing and item-delivery announcement” 410.

With respect to “cancelled announcements,” the present invention may provide for one or more “cancelled ride-sharing announcement” 411, “cancelled item delivery announcement” 412, and “cancelled ride-sharing and item delivery announcement” 413 choices. With respect to “cancelled ride-sharing announcement” 411, the present invention may provide for fillable fields or otherwise allow a requesting party to enter information pertinent to “where from,” “where to,” “when,” “valid until,” a map icon that links to a map function, a “cancel” function button, and a status notification that, in some embodiments, may read “status: cancelled.” With respect to “cancelled item delivery announcement” 412, the present invention may provide for fillable fields or otherwise allow a requesting party to enter information pertinent to “where from,” “where to,” “when,” “valid until,” a map icon that links to a map function, a “cancel” function button, and a status notification that, in some embodiments, may read “status: cancelled.” It is contemplated that the present invention may provide, in some embodiments, that similar features and sequences may also apply to “cancelled ride-sharing and item delivery announcement” 413.

With respect to the “make request” 430 choice or functionality, in some embodiments, when a requesting party selects this choice, the requesting party may then be invited to choose between “ride sharing request” 402, “item delivery request” 403, and “ride-sharing and item delivery request” 404. With respect to a “ride sharing request” 402, the present invention may provide for fillable fields or otherwise allow a requesting party to enter information pertinent to “where from,” “where to,” “number of seats,” which may be a drop-down menu, “number of luggage,” which may be a drop-down menu, “size,” which may be a drop-down menu, “when,” “valid until,” and “confirm request.” With respect to “confirm request,” the present invention may provide for a notice approximating a “request sent,” “finding someone to give you a ride on their way,” or other such notice.

With respect to “item delivery request” 403, the present invention may provide for fillable fields or otherwise allow a requesting party to enter information pertinent to “where from,” “where to,” “when,” “valid until,” “estimated weight,” “add item,” “items,” “request type,” and “confirm request.” The “add item” functionality may further provide for “name” and “quantity” fields, along with an “add” button. With respect to “items,” the present invention may provide for fillable fields or other information-receiving elements relative to “name,” and “quantity,” for one or more items. With respect to “request type,” the present invention may provide for “pickup,” or “purchase” buttons. With respect to “confirm request” the present invention may provide for a notice approximating a “request sent,” “finding someone to deliver for you on their way,” or other such notice. A similar sequence may apply, in some embodiments, for “ride-sharing and item delivery request” 404.

With respect to “check request status” 431 the present invention may provide for a “request received” notice, as well allow a user to select from “new request” 414, “in progress request” 418, “completed request” 422, and “cancelled request” 426 choices. With respect to “new request” 414, the present invention may enable a user to select from “new ride sharing request” 415, or “new item delivery request” 416, and “new ride-sharing and item delivery request” 417. With respect to a “new ride sharing request” 415, the present invention may provide for fillable fields or otherwise allow a requesting party to enter information pertinent to “where from,” “where to,” “when,” “request valid until,” and “request details.” With respect to “request details,” the present invention may provide information relative to the selected courier's name, picture, star rating, as well as “where from,” “where to,” a map icon with a linked map screen, “number of seats,” which may be a drop-down menu, “number of luggage,” which may be a drop-down menu, “luggage size,” which may be a drop-down menu, “when,” “valid until,” and “make an offer.” With respect to “make an offer,” the present invention may provide for “estimated fare,” “estimated pickup,” “estimated arrival,” and a “submit offer” button.

With respect to a “new item delivery request” 416, the present invention may provide for fillable fields or otherwise allow a requesting party to enter information pertinent to “where from,” “where to,” “when,” “request valid until,” and “request details.” With respect to item delivery “request details,” the present invention may provide information relative to the selected courier's name, picture, star rating, as well as “where from,” “where to,” a map icon with a linked map screen, “request type,” estimated weight,” “items,” and “make an offer.” With respect to “make an offer,” the present invention may provide for “item price,” “delivery charge,” “estimated time,” and a “submit offer” button. A similar sequence may apply, in some embodiments, for “new ride-sharing and item delivery request” 417.

With respect to the “in progress request” 418 choice or functionality, in some embodiments, when a requesting party selects this choice, the requesting party may then be invited to choose between “in-progress ride sharing request” 419, “in-progress item delivery request” 420, and “in-progress ride-sharing and item delivery request” 421. With respect to an “in-progress ride sharing request” 419, the present invention may provide for fillable fields or otherwise allow a requesting party to enter information pertinent to “where from,” “where to,” a map icon which may bring up a map function, “valid until,” a statement regarding status, such as “offer pending acceptance, please wait,” and “request details.” With respect to “request details,” the present invention may provide for “number of seats,” which may be a drop-down menu, “number of luggage,” which may be a drop-down menu, “size,” which may be a drop-down menu, “when,” “valid until,” and “offer detail,” and a “cancel offer” button. With respect to “offer detail,” the present invention may provide for “estimated fare,” “pickup time,” “arrival time,” and “offer valid until.”

With respect to an “in-progress item delivery request” 420, the present invention may provide for fillable fields or otherwise allow a requesting party to enter information pertinent to “where from,” “where to,” “when,” a map icon that brings up a map function, request type, either “purchase” or “pickup,” “valid until,” “estimated weight,” “number of items,” “name and quantity” of the items, and “offer detail.” With respect to “offer detail,” the present invention may provide for “item price,” “delivery price,” “total,” estimated time,” “complete order,” and “cancel order.” With respect to “complete order,” the present invention may provide an evaluation element, wherein a requesting party may choose a star rating. A similar sequence may apply, in some embodiments, for “in-progress ride-sharing and item delivery request” 421.

With respect to “completed requests” 422, the present invention may provide, in some embodiments, that when a requesting party selects this choice, the requesting party may then be invited to choose between “completed ride sharing request” 423, “completed item delivery requests” 424, or “completed ride-sharing and item delivery request” 425. With respect to a “completed ride sharing request” 423, the present invention may provide for fillable fields or otherwise allow a requesting party to enter information pertinent to “where from,” “where to,” a map icon which may bring up a map function, “valid until,” “when,” and “request details.” With respect to “request details,” the present invention may provide for “where from,” “where to,” “number of seats,” which may be a drop-down menu, “number of luggage,” which may be a drop-down menu, “luggage size,” which may be a drop-down menu, “offer details,” ratings,” and “buyer's feedback.” With respect to “offer detail,” the present invention may provide for “pickup time,” “arrival time,” and “offer valid until.” With respect to “ratings,” the present invention may provide for a star rating functionality and an open-text field. With respect to “buyer's feedback,” the present invention may provide for a star rating functionality and an open-text field.

With respect to “completed item delivery requests” 424, the present invention may provide for fillable fields or otherwise allow a requesting party to enter information pertinent to “where from,” “where to,” “when,” a map icon that brings up a map function, request type, either “purchase” or “pickup,” “valid until,” “estimated weight,” “number of items,” “name and quantity” of the items, and “offer details.” With respect to “offer details,” the present invention may provide for “item price,” “delivery price,” “total,” and “time,” “ratings,” and “buyer's feedback.” With respect to “ratings,” the present invention may provide for a star rating functionality and an open-text field. With respect to “buyer's feedback,” the present invention may provide for a star rating functionality and an open-text field. A similar sequence may apply, in some embodiments, for “completed ride-sharing and item delivery request” 425.

With respect to cancelled requests 426, the present invention may provide for “request detail,” “offer detail,” status descriptions including but not limited to offer declined, request cancelled, offer cancelled, request expired, offer expired, or other similar types of descriptions. One or more of these fields may be provided within the interfaces for “cancelled ride request” 427, “cancelled item delivery request” 428, and “cancelled ride sharing and item delivery request” 429.

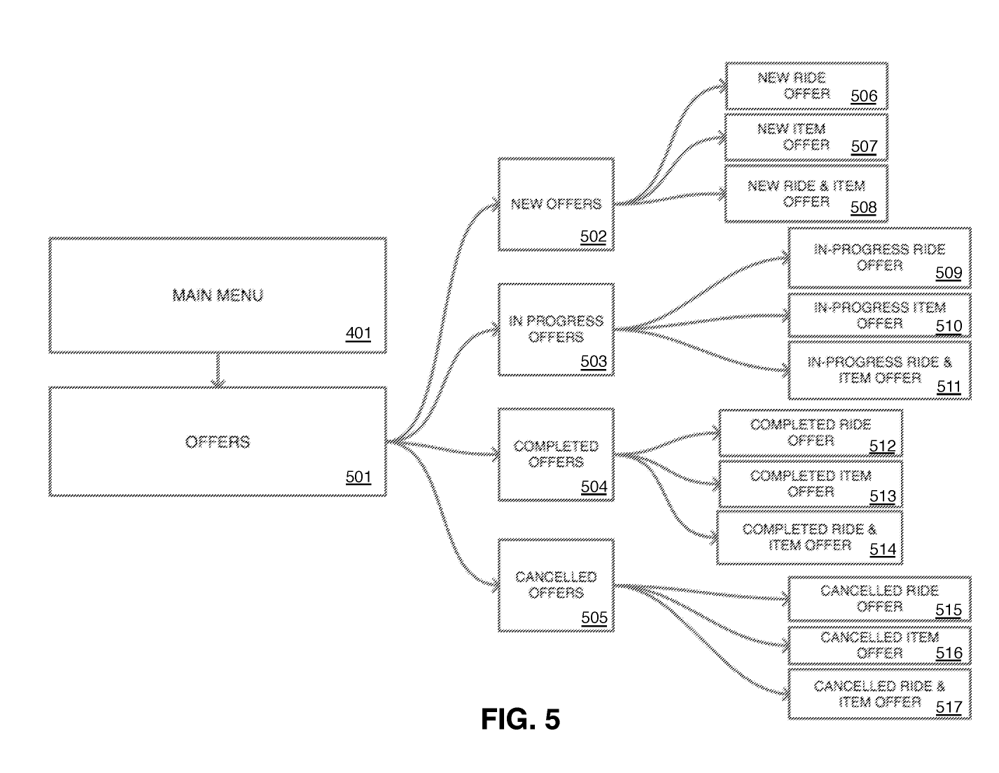

Turning attention to FIG. 5, from a courier's interface with the present invention, in some embodiments, the present invention may phrase its functionalities in terms of “offers” as contrasted with “requests.” From main menu 401, a user may select “offers” 501, and from there may select “new offers” 502, “in-progress offers” 503, “completed offers” 504 and “cancelled offers” 505. With respect to “new offers” 502, the present invention may invite the courier to choose “new ride-sharing offer” 506, “new item delivery offer” 507, or “new ride-sharing and item delivery offer” 508. With respect to a “new ride-sharing offer” 506, the present invention may provide for fillable fields or otherwise allow a requesting party to enter information pertinent to “where from,” “where to,” “when,” “request valid until,” and “offer details.” With respect to ride sharing “offer details,” the present invention may provide information relative to “estimated fare,” “pickup time,” “arrival time,” “offer valid until,” “where from,” “where to,” “number of seats,” which may be a drop-down menu, “number of luggage,” which may be a drop-down menu, “luggage size,” which may be a drop-down menu, as well as “accept” and “decline” buttons.

With respect to a “new item delivery offer” 507, the present invention may provide for fillable fields or otherwise allow a requesting party to enter information pertinent to “item charge,” “delivery charge,” “total,” “offer valid until,” “where from,” “where to,” a map icon which may bring up a map functionality, “request type,” as well as an “accept” and a “decline” button. With respect to “request type,” the present invention may supply information relative to the delivery request including but not limited to “delivery,” “pickup,” “items,” “quantity,” “name,” and “estimated weight.” The present invention may provide for a similar sequence or features with respect to “new ride-sharing and item delivery offer” 508.

With respect to “in-progress offers” 503, the present invention may provide for a user to select “in-progress ride-sharing offer” 509, “in-progress item delivery offer” 510, or “in-progress ride-sharing and item delivery offer” 511. With respect to “in-progress ride-sharing offer” 509, the present invention may provide for fillable fields or otherwise allow a requesting party to enter information pertinent to “where from,” “where to,” “when,” “valid until,” and “offer details.” With respect to “offer details,” the present invention may provide information relative to “estimated fare,” “estimated pickup time,” “estimated arrival time,” “where from,” “where to,” “when,” “request valid until,” and a “complete order” button. In some embodiments, the “complete order” button may bring up a screen providing “rating and review,” star-choice options, a “feedback” fillable text field, a “submit” button and a “send message” button.

With respect to an “in-progress item delivery offer” 510, the present invention may provide for fillable fields or otherwise allow a requesting party to enter information pertinent to “where from,” “where to,” “when,” “valid until,” “status: pending delivery,” and “offer details.” With respect to “offer details,” the present invention may provide for “item price,” “delivery charge,” “total,” “estimated delivery time,” “where from,” “where to,” “when,” “offer valid until,” a map icon which may bring up a map functionality, “estimated weight,” “request type,” “items,” “name and quantity” for each item, as well as “complete order” and “send message” buttons. In some embodiments, the “complete order” button may bring up a screen providing “rating and review,” star-choice options, a “feedback” fillable text field, a “submit” button and a “submit” button. The present invention may provide for a similar sequence or features with respect to “in-progress ride-sharing and item delivery offer” 511.

With respect to “completed offers” 504, the present invention may invite the user to choose between “completed ride-sharing offer” 512, “completed item delivery offer” 513, and “completed ride-sharing and item delivery offer” 514. With respect to “completed ride-sharing offer” 512, the present invention may provide information relative to the completed offer such as by way of example information falling into the following categories: where from, where to, when, when the offer was valid until, offer details, and rating. With respect to offer details, the present invention may provide information pertinent to the fare, the estimated fare, pickup time, arrival time, number of seats, number of luggage, luggage size, details about the request, including where from, where to, when, when the request was valid until. With respect to rating, the present invention may provide for fillable fields or otherwise receive information pertinent to the courier's “name,” star rating, fillable star rating field, the requesting party's “name,” star rating pertinent to the requesting party, and fillable star rating field pertinent to the requesting party.

With respect to a “completed item delivery offer” 513, the present invention may provide information relative to the completed offer such as by way of example information falling into the following categories: where from, where to, when, when the offer was valid until, offer details, and rating. With respect to offer details, item charge, delivery charge, total, where from, where to, when, when the request was valid until, items, and name and quantity for each item. With respect to rating, the present invention may provide for fillable fields or otherwise receive information pertinent to the courier's “name,” star rating, fillable star rating field, the requesting party's “name,” star rating pertinent to the requesting party, and fillable star rating field pertinent to the requesting party. The present invention may provide for a similar sequence or features with respect to “completed ride-sharing and item delivery offer” 514.

With respect to “cancelled offers” 505, the present invention may invite the courier to choose between “cancelled ride-sharing offers” 515, “cancelled item delivery offers” 516, and “cancelled ride-sharing and item delivery offers” 517. With respect to “cancelled-ride sharing offers” 515, the present invention may provide information relative to the cancelled offer such as by way of example information falling into the following categories: where from, where to, when, when the offer was valid until, and provide a status declaration including but not limited to offer expired or offer cancelled.

With respect to “cancelled item delivery offers” 516, the present invention may provide information relative to the completed offer such as by way of example information falling into the following categories: where from, where to, when, when the offer was valid until, and provide a status declaration including but not limited to offer expired or offer cancelled. The present invention may provide for a similar sequence or features with respect to “cancelled ride-sharing and item delivery offers” 517.

In order to facilitate the aforementioned functionality, various aspects may be performed by one or more of the mobile devices 102, 104, and 106. In one embodiment, the mobile devices are operative to perform, at least in part, the disclosures generally disclosed in FIGS. 3-5 as described above.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the electronic device 102, 104, or 106. The machine code may be converted from the source code, etc. If embodied in hardware, each block may represent a circuit or a number of interconnected circuits to implement the specified logical function(s).

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the present invention is not intended to be exhaustive or limited to the precise form disclosed above or to a particular field of usage.

While specific embodiments of, and examples for, the present invention are described above for illustrative purposes, various equivalent modifications are possible for which those skilled in the relevant art will recognize.

While certain aspects of the present invention disclosed are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. A method for arranging at least one delivery, the method being performed by a computing system and one or more processors, the method comprising:
(a) Receiving, from a first computing device, information from a courier, the information consisting of at least one route;
(b) Receiving, from a second computing device, at least one delivery request from a requesting party, the at least one delivery request including a description of at least one thing, at least one pickup location, at least one suggested fee, and at least one delivery location;
(c) Performing, by the computing system, an integration process wherein the at least one delivery request is integrated into the at least one route;
(d) Providing, to the first computing device, one or more of the at least one delivery requests to the courier;
(e) Receiving, from the first computing device, a first acceptance by the courier, wherein the first acceptance includes one or more of the at least one delivery requests and one or more initial fee proposals;
(f) Providing, to the second computing device, the first acceptance and the one or more initial fee proposals;
(g) Receiving, from the second computing device, a fee counter proposal;
(h) Providing, to the first computing device, the fee counter proposal;
(i) Receiving, from the first computing device, a second acceptance, wherein the second acceptance includes the delivery request and the fee counter proposal;
(j) Providing, to the second computing device, a notification of the second acceptance;
(k) Dispatching, by the computing system, the courier to execute the at least one delivery request;
(l) Receiving, from the first computing device, at least one status update concerning the courier's progress regarding one or more tasks required to complete the at least one delivery request;
(m) Communicating, to the second computing device, the at least one status update;
(n) Receiving, from the first computing device, at least one completion notice that the at least one delivery request is complete; and
(o) Communicating, to the second computing device, the at least one completion notice.

2. The method of claim 1, wherein the route is plotted via a software application having a map function, wherein the software application is accessible by the computing system, and wherein the route is represented as a line between two or more points.

3. The method of claim 2, wherein the route is represented as an area.

4. The method of claim 1, wherein the one or more delivery requests are provided to one or more couriers as one or more announcements presented via at least one public forum list.

5. The method of claim 1, wherein at least one of the at least one things is a person.

6. The method of claim 1, wherein the route comprises two or more stops.

7. The method of claim 1, wherein the route is a ground travel route.

8. The method of claim 1, wherein the route is an air travel route.

9. The method of claim 1, wherein the route is a water travel route.

10. A system for arranging at least one delivery, comprising:
an electronic device operative to:
receive information from a courier, the information consisting of at least one route;
receive at least one delivery request from a requesting party, the at least one delivery request including a description of at least one thing, at least one pickup location, at least one suggested fee, and at least one delivery location;
perform an integration process wherein the at least one delivery request is integrated into the at least one route;
provide one or more of the at least one delivery requests to the courier;
receive a first acceptance by the courier, wherein the first acceptance includes one or more of the at least one delivery requests and one or more initial fee proposals;
provide to the requesting party the first acceptance and the one or more initial fee proposals;
receive from the requesting party a fee counter proposal;
provide the fee counter proposal to the courier;
receive from the courier a second acceptance, wherein the second acceptance includes the delivery request and the fee counter proposal;
notify the requesting party of the second acceptance;
dispatch the courier to execute the at least one delivery request;
receive from the courier at least one status update concerning the courier's progress regarding one or more tasks required to complete the at least one delivery request;
communicate to the requesting party the at least one status update;
receive from the courier at least one completion notice that the at least one delivery request is complete; and
communicate to the requesting party the at least one completion notice.

11. The system of claim 10, wherein the route is plotted by a software application having a map function, wherein the software application is accessible by the computing system, and wherein the route is represented as a line between two or more points.

12. The system of claim 11, wherein the route is represented as an area.

13. The system of claim 10, wherein the one or more delivery requests are provided to one or more couriers as one or more announcements presented via at least one public forum list.

14. The system of claim 10, wherein at least one of the at least one things is a person.

15. The system of claim 10, wherein the status updates include the courier's location, if and when a courier arrives at the pickup location, if and when a courier picks up the thing, if and when a courier reaches the delivery location, and if and when a delivery request is complete.

16. The system of claim 10, wherein the route comprises two or more stops.

17. The system of claim 10, wherein the route is a ground travel route.

18. The system of claim 10, wherein the route is an air travel route.

19. The system of claim 10, wherein the route is a water travel route.

20. A non-transitory computer-readable medium storing instructions that, when executed by one or more processors of a computing system, are configured to:
receive a route from a courier;
receive at least one delivery request from a requesting party, wherein the at least one delivery request contains at least one suggested fee;
perform an integration process wherein the at least one delivery request is compared against the at least one route;
provide one or more of the at least one delivery requests to the courier;
receive a first acceptance by the courier, wherein the first acceptance includes one or more of the at least one delivery requests and one or more initial fee proposals;
provide to the requesting party the first acceptance and the one or more initial fee proposals;
receive from the requesting party a fee counter proposal;
provide the fee counter proposal to the courier;
receive from the courier a second acceptance, wherein the second acceptance includes the delivery request and the fee counter proposal;
notify the requesting party of the second acceptance;
dispatch the courier to execute the at least one delivery request;
receive from the courier at least one status update concerning the courier's progress regarding one or more tasks required to complete the at least one delivery request;
communicate to the requesting party the at least one status update;
receive from the courier at least one completion notice that the at least one delivery request is complete;
communicate to the requesting party the at least one completion notice;
receive one or more evaluations by the requesting party of the courier; and
receive one or more evaluations by the courier of the requesting party.
